(19) United States
(12) Patent Application Publication
(10) Pub. No.: US 2016/0210634 A1
(43) Pub. Date: Jul. 21, 2016

(54) METHOD AND SYSTEM FOR PROCESSING PAYMENTS

(71) Applicant: ENET IT GROUP, LLC, Miami, FL (US)

(72) Inventor: Alejandro Trujillo, Miami, FL (US)

(73) Assignee: ENET IT GROUP, LLC

(21) Appl. No.: 14/997,858

(22) Filed: Jan. 18, 2016

Related U.S. Application Data
(60) Provisional application No. 62/105,054, filed on Jan. 19, 2015.

(51) Int. Cl. G06Q 20/40

(52) U.S. Cl. CPC G06Q 20/4097

(57) ABSTRACT

A payment processing system, components thereof and associated methods are provided which may prevent fraud associated with financial transactions.

### CROSS-REFERENCE TO RELATED APPLICATION

This application claims priority from U.S. Provisional Application Ser. No. 62/105,054, filed Jan. 19, 2015, the disclosure of which is incorporated herein by reference.

### BACKGROUND

1. Technical Field

The technical field is related generally to methods and systems for processing payments. More particularly, such methods and systems may be configured to reduce fraud related to payment processes.

2. Background Information

There are several well established systems and methods related to the processing of payments which are handled electronically and rapidly using credit cards or debit cards. Fraud is a key problem related to the processing of payments, including the theft and use of someone else's credit card number or debit card number to illegally purchase goods or services. Additional fraudulent behavior which has become increasingly prevalent is commonly known as identity theft. In short, criminals steal the personal/financial information of a given individual as a result of an inability to completely protect that personal/financial information at various stages of a financial transaction.

Current systems, such as the standard “four party” system, may unfortunately put such personal/financial information at substantial risk of theft primarily due to the large number of people who have access to the information of the person buying goods or services or making a purchase. Without going into substantial depth related to such problems with these prior art systems, suffice it to say that under known systems, a given customer provides his or her credit or debit card information to a given merchant in order to make a purchase, thereby often exposing this personal/financial information to multiple parties who do not need to have access to or know this information. The present methods and systems are intended to substantially reduce the noted risk of fraud.

### SUMMARY

One method may comprise the steps of receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser; receiving at the payment processor from an electronic device of the potential purchaser a consumer settlement authorization indicating authorization by the potential purchaser to pay the purchase cost; and if there is a match between the retailer settlement request and the consumer settlement authorization, the payment processor processing payment of the purchase cost from an account represented by the card number if sufficient funds are available in the account.

Another method may comprise the steps of receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser; receiving at the payment processor from an electronic device of the potential purchaser a consumer settlement authorization indicating authorization by the potential purchaser to pay the purchase cost; and transmitting from the payment processor to at least one of the merchant and electronic device (a) an approval message indicating approval of payment of the purchase cost if there is a match between the retailer settlement request and the consumer settlement authorization, or (b) a denial message indicating denial of payment of the purchase cost if there is not a match between the retailer settlement request and the consumer settlement authorization.

Another method may comprise the steps of receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser; receiving at the payment processor from an electronic device of the potential purchaser a consumer settlement authorization indicating authorization by the potential purchaser to pay the purchase cost; and the payment processor processing payment of the purchase cost from an account represented by the card number if sufficient funds are available in the account and if a phone line number of the electronic device is active, and not processing payment of the purchase cost from the account if the phone line number is inactive.

### BRIEF DESCRIPTION OF THE SEVERAL VIEWS OF THE DRAWINGS

One or more sample embodiments are set forth in the following description and is/are shown in the drawings and is/are particularly and distinctly pointed out and set forth in the appended claims.

FIG. 1 is a diagrammatic view of a sample payment processing system.

FIG. 2 is a diagrammatic view of an electronic device/smartphone with a purchaser App.

FIG. 3 is a diagrammatic view including an initialization stage related to a sample payment processing method, including registration of the purchaser App with the payment processor program.

FIG. 4 is a diagrammatic view of a subsequent stage including entry of a merchant identifier into the purchaser App.

FIG. 5 is a diagrammatic view of a subsequent stage including initiation of a potential purchase of goods or services from the merchant.

FIG. 6 is a diagrammatic view of a subsequent stage including the purchaser's review and adjustment of the purchaser's requested withdrawal amount.

FIG. 7 is a diagrammatic view of a subsequent stage including the purchaser's use of the purchaser App to transmit an intent to pay to the payment processor program.

FIG. 8 is a diagrammatic view of a subsequent stage including approval of payment to the merchant.

Similar numbers refer to similar parts throughout the drawings.

### DETAILED DESCRIPTION

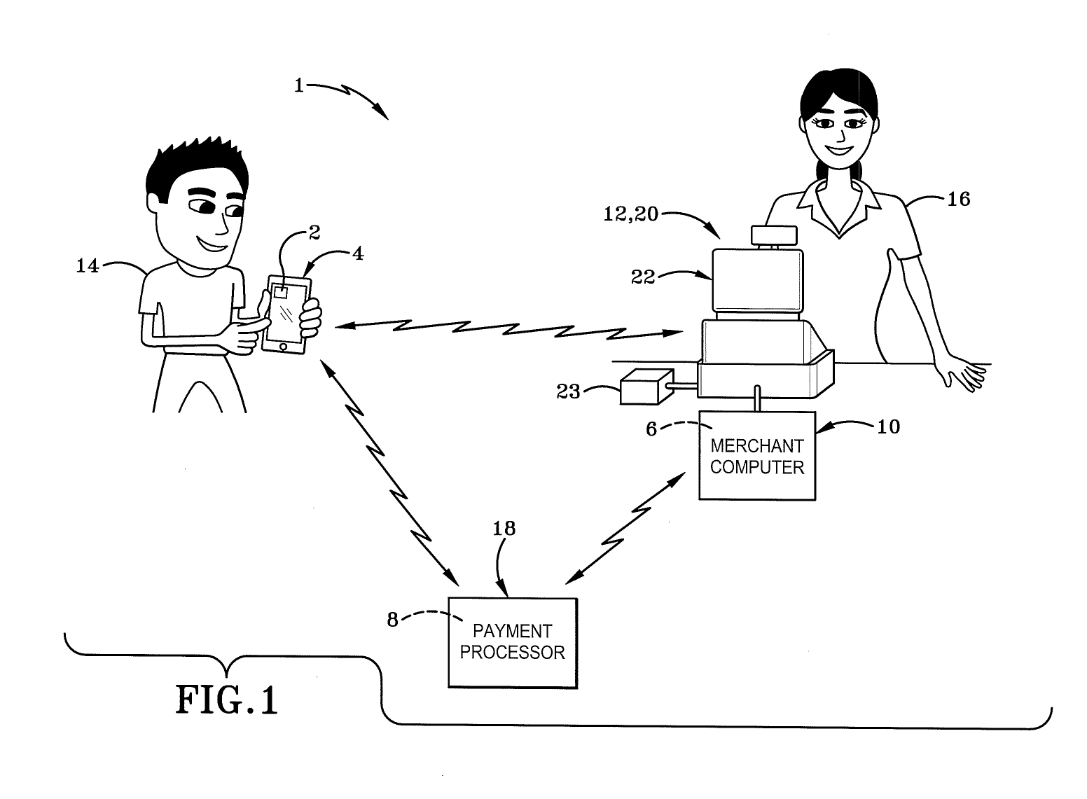

A sample embodiment of a payment processing system or financial transaction system is shown generally at 1 in FIG. 1. Generally, system 1 is set up to allow, facilitate or perform electronic fund transfers in a manner that reduces fraud, which has become increasingly problematic with prior art systems and methods, as discussed in the Background section of the present application. System 1 may include an electronic device or smartphone computer program or App 2 which may be run on the computer or operating system of an electronic device (ED), which may be or include a smartphone 4, a merchant or retailer computer program or App 6, and a payment processor computer program 8. App 2/ED/smartphone 4, App 6 and program 8 may be in electrical and/or wireless communication with one another as shown by the arrows extending therebetween in FIG. 1. Program or App 2 may be downloaded as an App from an App store, or may be loaded onto or saved on the ED/smartphone by any suitable method. App 2 may also be referred to as a purchaser computer program or App, a buyer computer program or App, a customer computer program or App, a consumer computer program or App or the like. Merchant program 6 may be loaded onto and run by a merchant operating system or computer 10 in communication with an electronic fund transfer point of sale (EFTPOS) terminal 12 of the merchant or retailer. App 2 may be associated with a given ED/smartphone 4, and/or with a given purchaser, buyer, consumer or customer 14, whereas merchant program 6 may be associated with a merchant or retailer 16, and payment processor program 8 may be associated with a payment processor 18. Terminal 12 may be located at a checkout or point of sale (POS) 20, which may be the area surrounding or adjacent a merchant's counter or cash register 22 where customers pay for goods or services sold by a merchant. A merchant reader and/or transmission device 23 at POS 20 may be in electrical or other communication with cash register 22, merchant computer 10 and App 6. Reader 23 may also be referred to as a customer or purchaser App reader, an ED/smartphone App reader or an ED/smartphone reader. Merchant or retailer App 6 may be located at or near a given cash register 22 or point of sale (POS) 20 although App 6 may be remote from and in communication with register 22, reader 23 and merchant computer 10.

Reader 23 may be any suitable reader and/or transmission device which is configured to read or access information from ED/phone 4/App 2 and/or transmit information to ED/phone 4/App 2. Near Field Communication (NFC) may be used for communication between ED/smartphone 4 and reader/transmission device 23. NFC is a short-range wireless connectivity standard that uses magnetic field induction to enable communication between devices when they touch one another or are brought within a few (typically about 10 or less) centimeters of each other. This connectivity standard may be the International Organization for Standardization/International Electrotechnical Commission (ISO/IEC) 18092 Standard or Standard Ecma-340 of Ecma International. Thus, ED/phone 4 may be an NFC-enabled ED/smartphone and reader/transmission device 23 may be an NFC-enabled reader or device. While NFC is one convenient way of transmitting information, other devices may be used. For instance, a laser beam emitter which emits a laser beam to transmit information to a laser reader may be used, wherein the ED/smartphone includes the laser reader and device 23 includes the laser emitter, or vice versa, or both. ED/phone 4 and reader/device 23 may be configured in any suitable manner known in the art to allow communications or transmission of information therebetween, and thus to allow transmission of information noted herein from consumer or customer 14/ED/phone 4/App 2 to merchant 16/App 6 and vice versa.

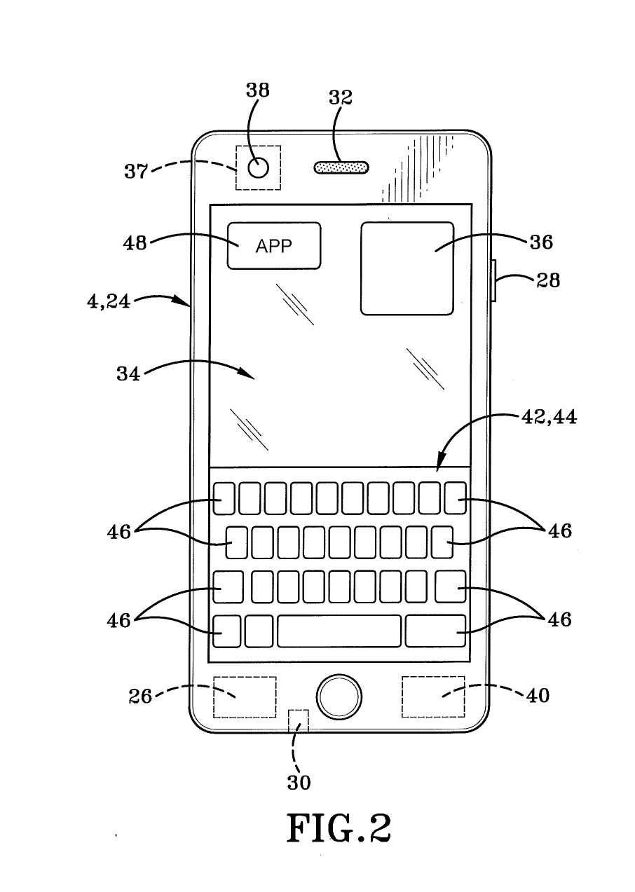

With primary reference to FIG. 2, ED/smartphone 4 may be any suitable ED/smartphone which may have standard phone capabilities and an onboard computer or operating system used to run various programs as known in the art, as well as to run purchaser/ED/smartphone App 2. ED/smartphone 4 is thus typically a handheld electronic device/cellular phone which may be easily carried by a person/owner 14 of cell phone 4 and which may fit in a purse or a shirt pocket or pants pocket. ED/smartphone 4 may include a body or frame 24 and various components mounted on or in frame 24 such as a battery 26, an on/off switch 28, a microphone 30, a speaker 32, a display or display screen 34, a bio-identification (bio-ID) mechanism 36, a camera 37 having a camera lens 38, a timer or clock 40, and various manual input interfaces 42. Manual input interfaces 42 may include, for example, a mouse and a keyboard or keypad 44 with various keys 46 such as alphabet keys and/or numeric keys and/or various other keys with other symbols or characters.

Battery 26 is configured for electrically powering the various functions or operations of ED/phone 4 and may be in electrical communication with on/off switch 28, microphone 30, speaker 32, screen 34, bio-ID mechanism 36, camera 37, clock 40, and input interfaces 42. On/off switch 28 is in electrical communication with the ED/smartphone operating system and is configured with on and off positions or states to turn the ED/phone/phone operating system on and off. Microphone 30 may be used in making telephone calls as the owner/customer speaks into the microphone. Microphone 30 may also be used as or as part of an audio or voice input interface by which the owner may verbally input commands or inquiries into ED/smartphone 4 which may be translated into electronic signals representing those commands or inquiries. Speaker 32 may be primarily used by the owner during phone calls so that the owner can hear another person's voice transmitted from another phone. Screen 34 may be pressure sensitive to allow the owner to manually input information or to manipulate various functions of the ED/smartphone. Various images may be visibly displayed on screen 34, including an App symbol 48 which is indicative of App 2 and which may be touched to open or provide access to App 2 to allow the owner to operate or use App 2. Bio-ID mechanism 36 may be, for example, a fingerprint reader or retina scanner, such that the fingerprint reader can read a fingerprint and/or the retina scanner can scan or read the retina of a person's eye, such as the owner's eye. Mechanism 36 may also use microphone 30 to receive a voiceprint of the owner. Thus, any of the mechanisms 36 may positively identify the owner of ED/smartphone 4, whether by use of such identifiers as the owner's fingerprint, voiceprint or retina scan. Mechanism 36 may thus be used as a security mechanism to allow only the owner of a given ED/smartphone 4 to operate ED/phone 4/App 2 and have access to information stored in ED/phone 4/App 2. A security mechanism for this purpose may also be provided through the use of a personal identification number (PIN) or passcode which the owner of ED/phone 4 may enter via the various input interfaces of ED/phone 4 noted herein. Camera 37 may be used to take photographs, such as still shots or photographs, or a streaming video or motion picture. Clock 40 may be configured to track or provide time by the hour, minute and second of a given day and the date including year, month and day. Clock 40 may thus provide an ED/phone time or time record and an ED/phone date or date record of when various events, operations or transactions occur within ED/smartphone 4. Manual input interfaces 42 may be used for inputting data into ED/phone 4 and/or manipulating data stored in ED/phone 4. The keys 46 of keypad 44 may be used to input alphabet characters, numeric characters, and/or other symbols or characters.

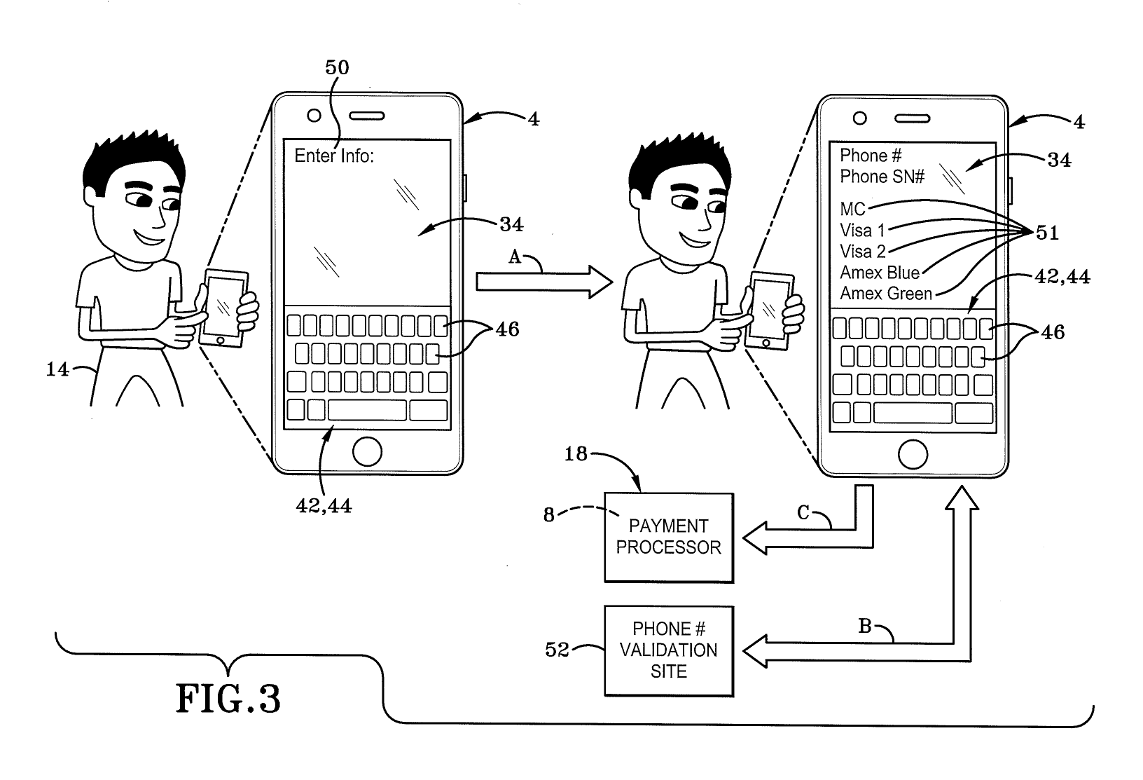

The operation of system 1 is now described with reference to FIGS. 3-8. For purposes of brevity, it is noted that for any step or action described herein as being performed by App 2, App 6 or program 8, that particular App or program may be said to include associated logic, or one or more logic circuits or a processor to perform that step or action or to be programmed to perform that step or action whether or not explicitly stated elsewhere in the present application. It is also noted that any of customer 14, ED/phone 4, App 2, merchant 16, App 6, computer 10, payment processor 18, program 8 or another entity may be said to transfer, send, transmit or communicate a message, a communication, a signal or information indicating or having a certain meaning to any other of these entities, such that it may be understood that the other of these entities receives or has received the given message, communication, signal or information, whether or not explicitly stated elsewhere in the present application. Except as otherwise noted, any transmission of information noted herein may be a wireless transmission, a transmission over one or more electrically conductive wires or fiber optic cables or other known transmission lines, or a combination thereof.

All transmissions of information between any of App 2, App 6 and program 8 may be encrypted. Likewise, transmissions between program 8 and bank computer 62 may be encrypted. More broadly, any transmission of information noted herein may be encrypted. Thus, system 1 may include encryption and decryption devices at or associated with each of App 2, App 6 and program 8 for respectively encrypting a given transmission sent from one of the encryption devices of Apps 2 or 6 or program 8 and decrypting a given encrypted transmission received at one of the decryption devices of Apps 2 or 6 or program 8.

With primary reference to FIG. 3, owner/customer/purchaser 14 may install computer program 2 on the operating system of ED/smartphone 4. As noted previously, this may be achieved by downloading App 2 from an App store or by any other suitable installation process. App 2 may be programmed with an initialization or activation subprogram or logic which may, after App 2 is installed or loaded in ED/phone 4, prompt owner/buyer 14 to initialize or activate App 2 for use with merchant App 6 and payment processor program 8. This initialization or activation process may include App 2 requesting owner/consumer 14 to register or enter relevant information (which may be referred to as initialization information, activation information or registration information) regarding one or more cards or methods of payment (MOP), the ED's/smartphone's phone number or P# (which may also be referred to as phone line number, phone dial number or phone dialing number) and the ED's or smartphone's ED serial number or phone serial number (PS#). The phone line number would have been assigned to the given smartphone 4 by a given phone company or phone carrier. The ED/phone serial number is a unique identifier of the given ED/smartphone 4 which is typically coupled to that ED/phone 4 at the time of manufacture of the given ED/phone 4. The PS# may be made up of numbers and/or alphabetical characters and/or other symbols or characters. The PS# may be imprinted on a component of the ED/phone and/or saved or stored within a database of the ED's/phone's onboard computer/operating system. The ED/phone line number (P#) may likewise be saved or stored within a database of the ED/phone's onboard computer/operating system.

App 2 may make such a request for entry of the above-noted or other information by displaying a prompt 50 on screen 34—here, prompt 50 is shown as “Enter info:” on the display screen although various other suitable prompts may be used. App 2 may thus be programmed to provide or produce such a prompt on screen 34. For instance, prompt 50 may request or suggest entry of various information related to a given credit card or debit card, which may include the cardholder's 14 name, the cardholder's billing address, the card type (e.g., Visa, Mastercard, American Express, Discover and so forth), the card number (commonly a 16-digit number), the card expiration date (commonly month and year), and the card security code or CSC (commonly a 3-digit or 4-digit number). A prompt like prompt 50 may also prompt or request owner/cardholder 14 to enter into App 2 an alias or nickname 51 for each MOP/card, so that a given nickname 51 serves as a MOP or card identifier (i.e., which is not the card number), which the owner may enter (Arrow A in FIG. 3) into App 2 and which App 2 may save for subsequent reference and use. App 2 may thus be programmed to receive and store or save nicknames 51. FIG. 3 shows example card identifiers, aliases or nicknames 51 for five different MOPs or cards, specifically “MC”, “Visa 1”, “Visa 2”, “Amex Blue” and “Amex Green”. These nicknames are shown as alphabetic or alphanumeric identifiers although any suitable symbols or characters may be used to provide such nicknames or aliases.

Owner/consumer 14 may enter the above-noted requested information into a database of App 2 via various manual input interfaces 42 such as a mouse or keys 46; and/or via a voice input interface/voice recognition component of ED/phone 4 including microphone 30; and/or a photo recognition interface/component of ED/phone 4 including camera 37 and lens 38 (such that owner 14 may take a photograph of the front and/or back of the card whereby the relevant information may be obtained through the photographic image or images); and/or an electromagnetic reader of or in communication with ED/phone 4 which may read a magnetic strip on the back side of the card to access or obtain the card information; and/or an RFID reader of or in communication with ED/phone 4 which may read a RFID chip on or in the card to access or obtain the card information; and/or any other suitable input interface known in the art. App 2 may thus be programmed to receive this and other information via such input interfaces. App 2 may also be programmed to automatically extract and receive the phone line number and ED/phone serial number from the ED/phone computer database whereby the owner/cardholder does not need to enter or input this information. However, the P# and PS# may be entered into App 2 by the owner. App 2 may store or save this extracted or entered information in its database.

App 2 may also be programmed to verify, confirm or validate that the phone line number of ED/phone 4 is active. For instance, App 2 may be programmed to automatically access a phone number validation site 52 for this purpose. Site 52 may be an interactive database located online/on the Internet at a website or may be a site set up and run by a phone company/carrier. In short, as represented by Arrow B in FIG. 3, App 2 may send a request/inquiry or request transmission to site 52 as to whether the phone line number of ED/phone 4 is active, and in response receive an indicator signal or communication (also Arrow B) from site 52 indicating that the phone line number is active or inactive. App 2 may be programmed to require that the phone line number be active in order to finalize the initialization or activation process.

After verifying that the phone line number of ED/phone 4 is active and at least one valid MOP/card has been entered into App 2, App 2 may transmit or send (Arrow C in FIG. 3) to payment processor program 8 the information associated with each MOP (cardholder name, billing address, card type, card number, card expiration date and card security code), the phone line number, the ED/phone serial number (or other ED/phone identifier as discussed elsewhere herein) and the alias or nickname 51 of each given MOP, which are stored in a payment processing database or memory accessible to program 8, thus creating a cardholder-specific record for each MOP associated with the cardholder or owner of the MOP and ED/smartphone 4. In this payment processing database, each MOP/card/card number may thus be associated with, linked to or represented by a given nickname or identifier 51. Thus, each identifier 51 is associated with or linked to each other piece of information associated with the MOP/card that is identified by the given identifier 51, and each of these pieces of information is interlinked or associated with one another, whereby accessing a given identifier or one of these pieces of information may automatically provide access to the other linked or interlinked pieces. However, this access may be limited or secured so that these various pieces of information stored or saved in the payment processor program database are not available or accessible to the merchant via the merchant computer or otherwise. Likewise, these pieces of information are not generally accessible, and payment processor computer program 8 may be programmed to release them only to limited entities, such as a bank which is the card issuer of the given credit or debit card of the cardholder, or the bank at which is located the cardholder's credit or debit account associated with or represented by a given card/card number.

App 2 may be programmed so that, after a given MOP/card is registered or recorded in the payment processor database, the MOP/card identifier is stored/saved in the App 2 database, whereas none of the card information of the given MOP/card is stored or saved in the App 2 database/memory, in the database of ED/smartphone 4, nor in any database which may be carried by ED/phone 4. Thus, it may be that, for any given MOP/card, some or all of the following are not stored or saved in these ED/phone-related or ED/phone App-related databases: the cardholder's name, billing address, card type, card number, card expiration date and card security code. Thus, App 2 may be programmed to ensure that these ED/phone-related or ED/phone App-related databases do not contain any financially sensitive data after it has been transmitted from App 2 to program 8 and/or saved or recorded in the program 8 database.

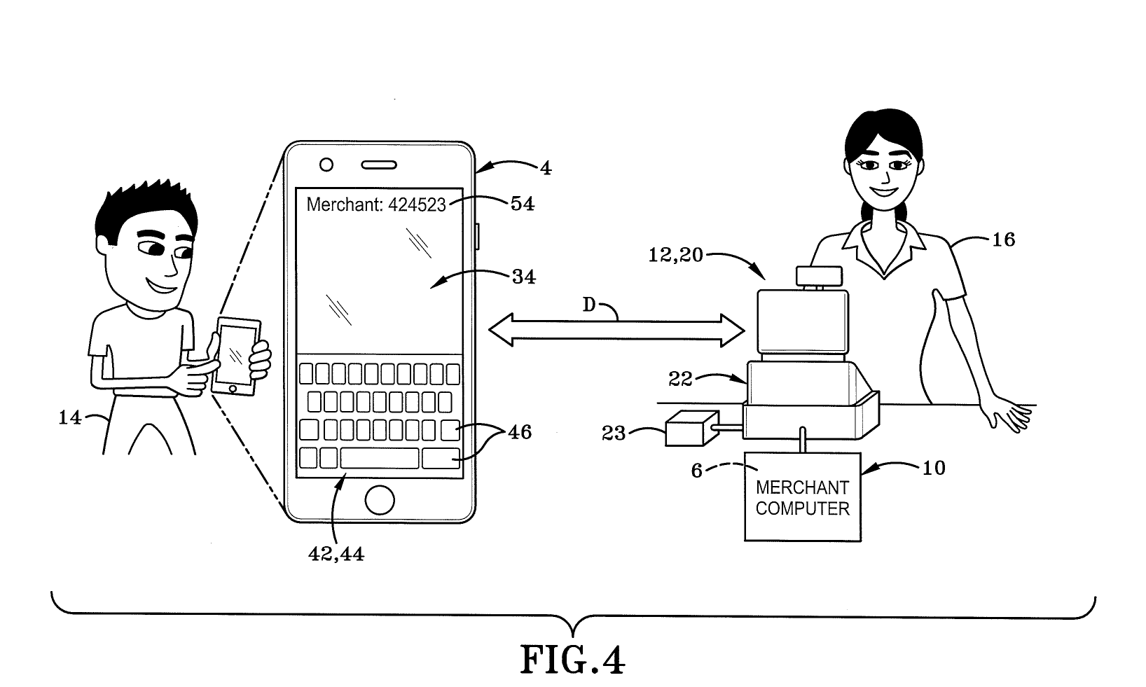

After registration of or setting up the record in the payment processing database of program 8, customer/buyer 14 may use App 2 to make a purchase from a given merchant 16, as detailed with reference to FIGS. 4-8. On a first purchase at a given merchant (FIG. 4), that merchant (merchant identifier or identification number or MID 54) may be registered on App 2. Thus, App 2 may receive (Arrow D in FIG. 4) from the merchant/App 6 the MID and may record or store the MID such that the merchant may be registered on App 2. This registration allows App 2 to receive coupons or other purchase discounts or offers, and/or advertising and so forth. The coupons or discounts may be automatically applied during a given purchase, which may include applying the discount for the purchase during which the coupon/discount was made available, or saving and applying the coupon/discount for a subsequent purchase.

During the first or a subsequent purchase from a given merchant, the transfer of information from buyer App 2/ED/smartphone 4 to merchant App 6 and from merchant App 6 to buyer App 2/ED/smartphone 4 may be done via reader/device 23. ED/smartphone App 2 and merchant App 6 are thus programmed to transmit and receive relevant information from one another. If the merchant or retailer has a back office server (through which a buyer's personal/financial information might otherwise have been communicated with prior art systems), App 6 may be programmed so that the back office server is preferably not engaged or in communication with merchant App 6, thereby preventing any of the buyer's personal/financial information which is transmitted to merchant App 6 from being transmitted to the back office server. This minimizes or reduces exposure of the customer's personal/financial information to potential thieves, thereby reducing the likelihood of theft of this information (e.g., card type, expiration date, card number and/or CSC of credit card or debit card; cardholder's name and address; etc.).

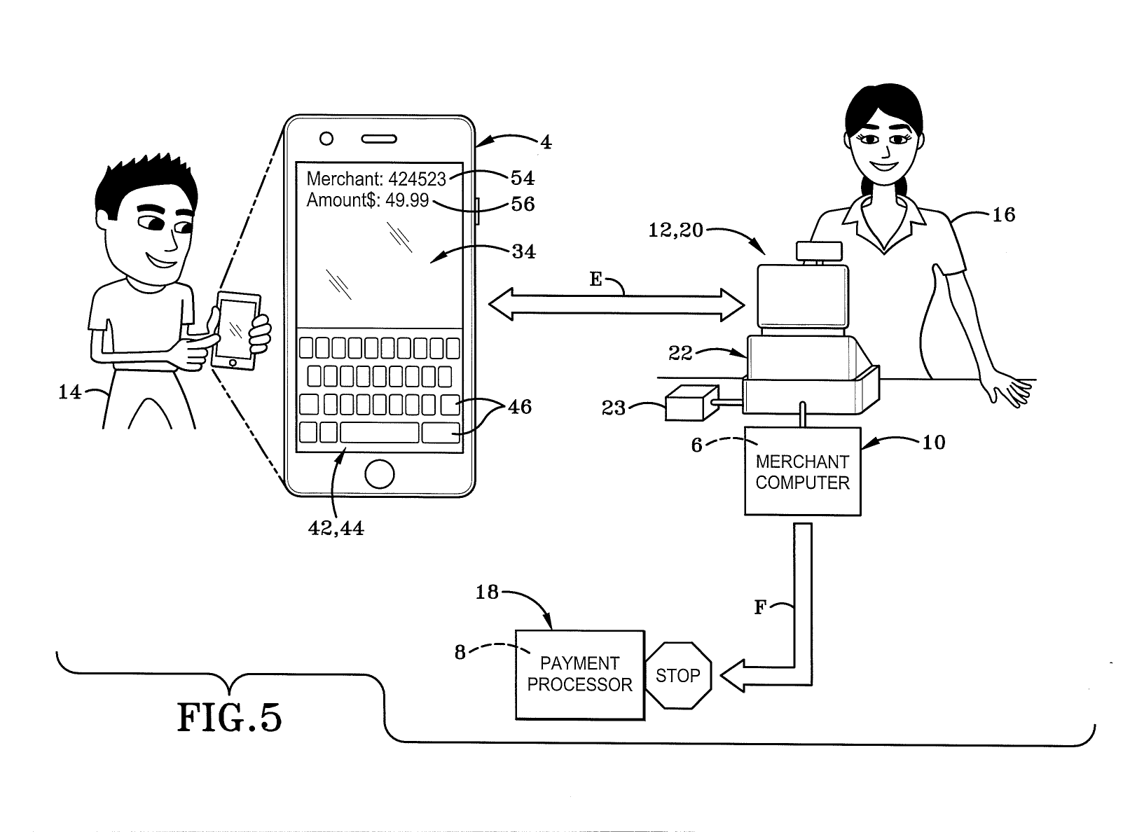

After the purchaser's/smartphone App 2 is registered, a given merchant has a registered merchant App 6, and the given merchant/MID 54 has been entered into the purchaser's App, the purchaser may make a purchase with the ED/smartphone App from the given merchant. Generally, in order to make the purchase, the retailer or merchant may provide merchant sale information to the customer/the customer's ED/smartphone App 2; the customer or purchaser may provide customer or ED/phone transaction information to the merchant/merchant App 6; and payment processor program 8 may authorize payment of a purchase amount or cost if it is determined that there is a match between the merchant sale information and the ED/phone transaction information, and if sufficient funds are available. Arrow D in FIG. 4 represents the transmission and receipt of information (especially the merchant sale information and the customer/ED/phone transaction information) to and from App 2/ED/phone 4/customer 14 and App 6/computer 10/merchant 16. The merchant sale information (represented by Arrow E in FIG. 5) may include the merchant identification number (MID) of the given merchant, a register transaction number (R#) which is linked to or associated with a (potential) given sale or transaction, the register time (RT) or time which is indicated or displayed by the register 22 used for the given sale/purchase when the merchant sale information is transferred to the ED/smartphone App, the register date or RD (month, day and year) which is indicated or displayed by the register used for the given sale or purchase when the merchant sale information is transferred to the ED/smartphone App and the purchase cost or amount ($) for given goods and/or services.

More particularly, merchant sale information for a given (potential) sale or purchase is transferred, sent, transmitted or communicated (Arrow E) from the merchant/merchant App 6 to the customer's ED/smartphone App 2 and entered into App 2. This may occur by NFC, voice or another method. For instance, the purchaser may place or position the ED/smartphone/App near or adjacent reader 23 to obtain this information from the merchant. Placing or positioning the ED/smartphone/App sufficiently close to reader 23 allows reader 23 to transmit the merchant sale information to the ED/smartphone App from the merchant so that App 2 may receive the merchant sale information and enter/record/store it in the App 2 database.

Alternately, a cashier or other merchant representative 16 of the given merchant may give the merchant sale information to the customer/potential purchaser verbally and/or in writing so that the customer may enter or input the merchant sale information into the ED/smartphone App by hand or voice, for instance, by using the ED's/smartphone's keypad and/or other manual input interfaces 42 of ED/smartphone 4 or by speaking into a sound input interface including microphone 30 of the ED/smartphone. The merchant or retailer representative may also directly enter the merchant sale information by hand or voice or other method into the customer's ED/smartphone App if the customer consents, for instance, by likewise using the ED's/smartphone's manual or sound input interfaces. One of skill in the art will understand that other communication interfaces may be used to transfer the merchant sale information from the merchant/App 6 to the ED/smartphone App 2 and vice versa.

While the customer is at point of sale 20 with ED/smartphone 4, customer/ED/phone transaction information may be transmitted, sent, forwarded or communicated from the customer/ED/phone 4/App 2 to the merchant/App 6, as also represented by Arrow E in FIG. 5. The ED/phone transaction information may include the ED/phone time (PT), ED/phone date (PD), phone line number (P#) of the ED/smartphone, ED/phone serial number (PS#) of the ED/smartphone, ED/phone transaction number (T#) and the purchase cost or amount ($) for given goods and/or services. The ED/phone transaction information which is sent may include all of the above-noted pieces of data, a combination of these pieces, or only one piece, for instance, the phone line number. The purchase cost, amount or price, which may be referred to as the initial purchase cost, amount or price, is shown at 56 in FIG. 5. The ED/phone time or PT may be the time which is indicated or displayed by the given ED/smartphone used for the given sale/purchase when the ED/phone transaction information is transferred to the merchant, which may be the same as or similar to the time for the given sale/purchase when the merchant sale information is transferred to the ED/smartphone App, or the same as or similar to the register time (RT). The ED/phone date or PD may be the date (month, day and year) which is indicated or displayed by the given ED/smartphone used for the given sale/purchase when the ED/phone transaction information is transferred to the merchant/App 6, which is normally the same as the date for the given sale/purchase when the merchant sale information is transferred to the ED/smartphone App, and which is normally the same as the register date (RD). The ED/phone transaction number or T# is linked to or associated with a (potential) given sale or transaction. ED/smartphone App 2 may be programmed to produce the T# for each given sale or transaction. Preferably, the customer/ED/phone transaction information transferred to the merchant/App 6 does not include any card number of the customer's credit card or debit card, and the customer's card numbers are never provided to nor accessed by the merchant/merchant App 6/merchant computer 10 from any source, including payment processor program 8.

The transmission of customer/ED/phone transaction information for a given (potential) sale or purchase from the customer/App 2 to the merchant/App 6 may occur by NFC, voice or another method similar to those described above with respect to transmission of merchant sale information from the merchant/App 6 to the customer/App 2/ED/phone 4. App 6 may receive/enter/record/store the ED/phone transaction information.

Alternately, the customer or representative of the customer may give the ED/phone transaction information to the merchant verbally and/or in writing so that the merchant may enter or input the ED/phone transaction information into the merchant's register/system by hand or voice, for instance, by using manual input interfaces of a device owned by the merchant or by speaking into a sound input interface microphone of such a merchant-owned device. The customer or customer's representative may also directly enter the ED/phone transaction information by hand or voice into the merchant's device if the merchant or merchant's representative consents, for instance, by likewise using the merchant's manual or sound input interfaces.

Once the ED/phone transaction information has been transferred to and saved by merchant App 6, the merchant App 6 may send (Arrow F in FIG. 5) to payment processor 18/program 8 merchant transaction validation information or a retailer settlement request (RSR) which may include some or all of the merchant sale information and some or all of the ED/phone transaction information. As represented by the diagrammatic stop sign in FIG. 5, program 8 may be programmed to suspend a sale transaction corresponding to the given potential sale/purchase and merchant transaction validation information/RSR received from merchant App 6 until program 8 receives certain matching information from the customer/ED 4/App 2.

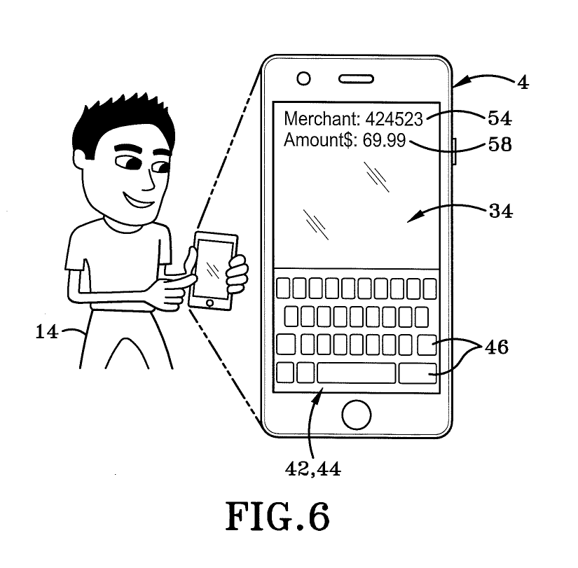

FIG. 6 illustrates that consumer 14 may, if allowed by the merchant, adjust or change the initial purchase amount, cost or price 56 (FIG. 5) to an adjusted amount, purchase cost or price 58 using one of the input interfaces of ED/phone 4. ED/phone App 2 may be programmed to provide a prompt or request on screen 34 to ask customer 14 if he or she wishes to adjust the initial amount 54 and may be programmed to receive any such input indicative of the adjusted amount 56. Customer 14 may elect such an adjustment in the case in which customer 14 wishes cash back from the merchant. Thus, for instance, FIGS. 5 and 6 represent that customer 14 has requested an additional amount of $20.00 be added to the sample initial amount of $49.99 so that the sample adjusted amount is $69.99. Customer/consumer 14 may thus request that the adjusted amount be charged to/against or withdrawn or debited from the credit or debit account associated with or represented by the chosen MOP/card/card number for the given purchase/sale in order to pay the initial cost to the merchant and credit the additional amount to the merchant so that the merchant may give the customer the additional amount in cash.

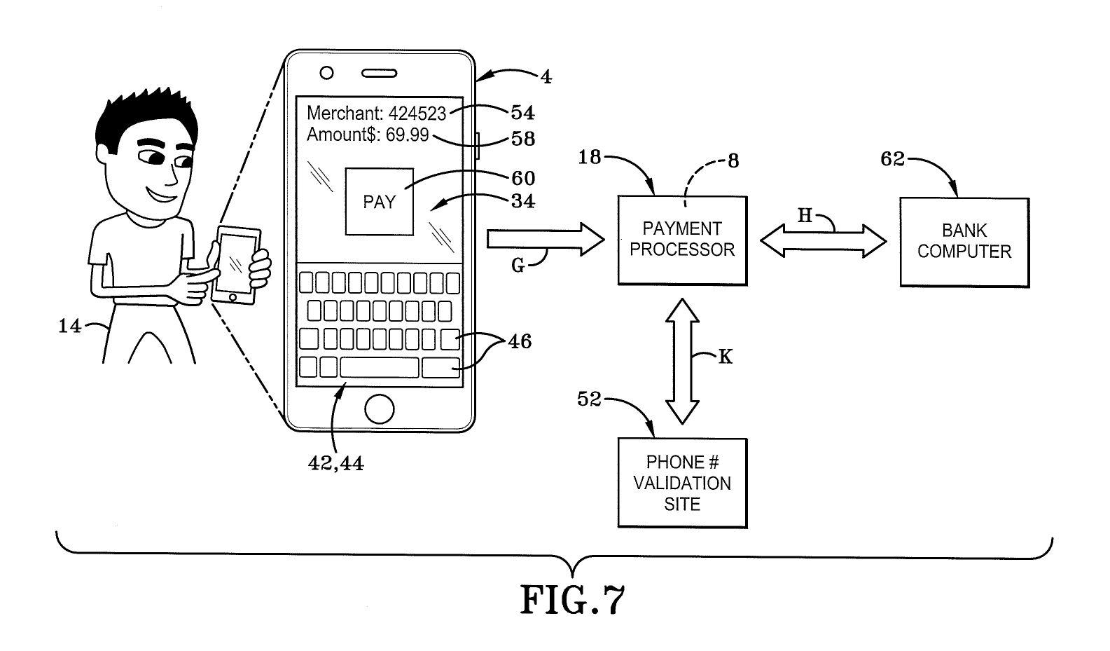

After the merchant sale information has been transferred to and saved by App 2 and customer 14 has made an adjustment, if any, to the cost, customer 14 may communicate to App 2 a command to pay the final amount 58 (adjusted or not). This command may be in response to a prompt generated by App 2, such as a pay prompt 60 (FIG. 7) on screen 34. Customer 14 may communicate the command to App 2 by various input interfaces of ED/phone 4 (manual, voice, etc.), at which time ED/smartphone App 2 may send (Arrow G in FIG. 7) to the payment processor program 8 customer transaction validation information or a consumer settlement authorization (CSA) which may include some or all of the merchant sale information, some or all of the ED/phone transaction information, and the ED/phone serial number or other ED/phone identifier or ED/phone App identifier. Such other identifier may be linked to ED/smartphone 4 or App 2 or customer/owner 14 of ED/smartphone 4/App 2. Like the ED/phone serial number, it may be that this is not communicated to the merchant/App 6. The ED/phone serial number or other identifier serves as an identifier of a specific ED/phone 4, and may have been transmitted from App 2 to program 8 during the initialization process discussed earlier, that is, transmitted from App 2 to program 8 before the transmission of the RSR and CSA to payment processor 18/program 8.

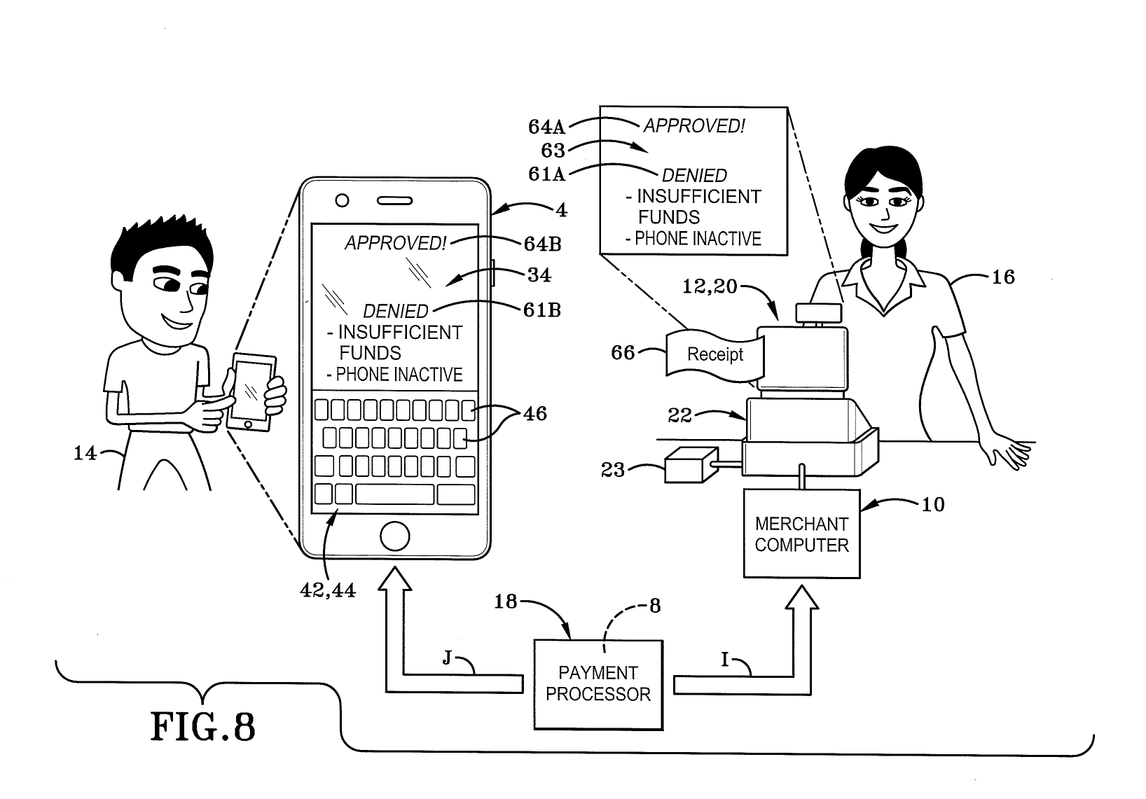

Once the merchant transaction validation information or RSR and the customer transaction validation information or CSA is received by payment processor 18/program 8, program 8 may determine if there is a match between the RSR and CSA or between predetermined pieces of the merchant transaction validation information/RSR and the customer transaction validation information/CSA. If processor 18/program 8 determines there is not such a match, then program 8 will not proceed with processing the payment requested by customer 14 via App 2 (and thus may not transmit any communications to bank computer 62), and will transmit (Arrow I in FIG. 8) a denial message 61A to merchant App 6 and thereby to merchant 16, as well as transmit (Arrow J in FIG. 8) a denial message 61B to customer App 2 and thereby to customer 14. Denial message 61A may be displayed on a monitor, screen or display 63 at the point of sale, such as a display of register 22. Denial message 61B may be displayed on display or screen 34 of ED/phone 4. Messages 61 may be visible, as those shown in FIG. 8 and/or may be represented by an audible sound which may be emitted by speaker 32 of ED 4 and/or by a speaker of register 22. Denial messages 61 may include a message such as “Denied” indicating denial of payment of the purchase cost with funds from the account represented by the card number/card which customer 14 selected and directed be used for such payment via processing via program 8.

If processor 18/program 8 determines there is such a match, payment processing may still be denied for various reasons, for instance, because of insufficient funds. After determining the match, processor 18/program 8 may send an inquiry to bank computer 62 to determine whether bank computer 62 approves or denies payment from the account represented by the card number, such as may be based on sufficient funds or insufficient funds, respectively. If there is a match, but not sufficient funds, processor 18/program 8 may then decline to process the payment and may also send appropriate denial messages to retailer 16 and consumer 14.

Denial messages 61 may include information other than a simple denial message, for instance, information which may indicate why the processing of the sale or payment of the purchase cost was denied. Messages 61 may include “Insufficient funds” or something similar indicating that the payment denial was due to insufficient funds in the account represented by the card/card number. Denial of purchase payment may also occur if too much time has elapsed (e.g., 30, 45 or 60 seconds; usually not more than 60 or 90 seconds), for instance, from the time of the transmission of the RSR and CSA to processor 18/program 8, or from the time of determining the match, or from another predetermined start time. Where too much time has elapsed, messages 61 may likewise be communicated as noted above, and may be displayed without a reason given or with a reason given, whereby each message 61 may include a portion such as “time elapsed” or the like.

Further, program 8 may be programmed to determine whether the phone line number of ED/phone 4 that program 8 received from App 2 during the transmission of the customer transaction validation information/CSA is active or not. This determination may be done by making, sending or transmitting an inquiry (Arrow K in FIG. 7) to a phone number validation site 52, in a manner previously discussed with respect to App 2 and FIG. 3. That is, processor 18/program 8 may send a request/inquiry or request transmission (Arrow K) to site 52 as to whether the phone line number of ED/phone 4 is active, and in response receive an indicator signal or communication (also Arrow K) from site 52 indicating that the phone line number is active or inactive. If processor 18/program 8 discovers that the phone line number is not active, processor 18/program 8 may not proceed with processing the requested payment and may send to App 2/customer 14 and to App 6/merchant 16 denial messages 61 which indicate that payment is denied/will not be made, and which may also specify that the phone line number is not active/inactive. Thus, for instance, denial messages 61 may include “Phone inactive” or the like to indicate that the phone line number is inactive and that this inactive status is the reason for payment denial.

If program 8 determines that there is a match between the RSR and CSA, or between predetermined pieces of the CSA/customer transaction validation information and the RSR/merchant transaction validation information, and that the phone line number is active, processor 18/program 8 may then extract from the program 8 database or record the card number and any other relevant information related to the given card/MOP, and communicate (Arrow H in FIG. 7) to the bank computer 62 of the bank associated with (or which issued) the selected MOP/card/card number to proceed with processing the requested payment. It may be that processor 18/program 8 will proceed with processing the payment only if there is a match and/or only if the phone line number is active. Once processor 18/program 8 determines that any such needed criteria have been met, processor 18/program 8 may communicate or transmit to bank computer 62 the card number and any other relevant information (e.g., the purchase cost, CSC, etc) related to the given card/MOP needed to process the given payment. Processor 18/program 8 may send an inquiry to bank computer 62 to determine whether or not bank computer 62 approves or denies payment from the account represented by the card number, such as may be based on sufficient funds or insufficient funds, respectively, and may receive from bank computer 62 an approval or denial communication indicating that there are sufficient or insufficient funds in the account to pay the requested payment.

If processor 18/program 8 determines that there are sufficient funds/that the requested payment is approved by bank computer 62, processor 18/program 8 may proceed with processing the payment. Payment processor 18/program 8 may thus direct payment of the requested payment by directing bank computer 62 to pay the merchant from the account represented by the card number submitted by processor 18 to bank computer 62, which may involve charging the purchase cost to a credit account or charge account represented by a credit card or card number of a credit card, or debiting the purchase cost from a bank account or debit account represented by a debit card or card number of a debit card. If processor 18/program 8 determines that there are sufficient funds/that the requested payment is approved by bank computer 62, may also send an approval message to both merchant 16 via App 6 and customer 14 via App 2 (respectively, Arrows I and J in FIG. 8). FIG. 8 shows an example payment approved or approval message or indicator 64A and 64B, indicating to the retailer 16 and customer 14 the payment approval. Approval message 64A may be displayed on screen 63 at the point of sale. Approval message 64B may be displayed on screen 34 of ED/phone 4. Messages 64 may be visible, as those shown in FIG. 8 and/or may be represented by an audible sound which may be emitted by speaker 32 of ED 4 and/or by a speaker of register 22. App 6 may also communicate to cash register 22 to produce a receipt 66 for the purchase or sale, which the merchant 16 may give to customer 14.

One or more of the methods herein may include various of the following, some or all of which have been previously noted or stated in similar or different ways. One method may involve receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser, and receiving at the payment processor from an electronic device of the potential purchaser a consumer settlement authorization indicating authorization by the potential purchaser to pay the purchase cost. The method may also include, if there is a match between the retailer settlement request and the consumer settlement authorization, the payment processor may process payment of the purchase cost from an account represented by the card number if sufficient funds are available in the account. The payment processor may transmit to the electronic device and/or the merchant an approval message indicating that payment of the purchase cost from the account has been approved or a denial message indicating that payment of the purchase cost from the account has been denied. This transmission of the approval message may occur if there is a match between the retailer settlement request and the consumer settlement authorization, and transmission of the denial message may occur if there is not a match between the retailer settlement request and the consumer settlement authorization.

The retailer settlement request may include merchant sale information including at least one of a merchant identification number of the merchant; a register transaction number which is obtained from a merchant cash register and linked to a potential sale associated with payment of the purchase cost; a register time which is obtained from a merchant cash register and linked to a potential sale associated with payment of the purchase cost; a register date which comprises month, day and year and which is obtained from a merchant cash register and linked to a potential sale associated with payment of the purchase cost; and the purchase cost. The retailer settlement request may include customer or ED transaction information which the merchant received from the electronic device, which may include the customer or ED transaction information listed below or elsewhere herein.

The consumer settlement authorization may include customer or ED transaction information including at least one of: an electronic device transaction number which is obtained from the electronic device and linked to a potential sale associated with payment of the purchase cost; an electronic device time which is obtained from the electronic device and linked to a potential sale associated with payment of the purchase cost; an electronic device date which comprises month, day and year and which is obtained from the electronic device and linked to a potential sale associated with payment of the purchase cost; a phone line number of the electronic device; an identifier of the electronic device; and the purchase cost. The consumer settlement authorization comprises merchant sale information which the electronic device received from the merchant. This merchant sale information which the ED received from the merchant may include the merchant sale information listed above.

The consumer settlement authorization may include a piece of information which is not included in the retailer settlement request and which necessary for the payment processor to process the payment of the purchase cost from the account. This piece of information may comprise an electronic device identifier of the electronic device and/or a phone line number of the electronic device. The electronic identifier may be an electronic device serial number of the electronic device.

It may be that the consumer settlement authorization does not include the card number. The consumer settlement authorization may include an alias for the credit card or debit card, and the payment processor may extract the card number from a payment processing database based on the alias. It may also be said that the payment processor may use the alias to extract the card number from the database. Before the payment processor receives the retailer settlement request and consumer settlement authorization, the payment processor may receive from the electronic device registration information which includes the card number and an alias which is not the card number and which serves as a card identifier of the credit card or debit card, and may store the card number and alias in the payment processing database, which is accessible to the payment processor. It may be that the payment processor does not communicate the card number to the merchant.

It may be that the payment processor sends to a phone number validation site an inquiry as to whether a phone line number of the electronic device is active. It may be that the payment processor processes payment of the cost only if the phone line number is active. Thus, the payment processor may process payment of the purchase cost from an account represented by the card number if sufficient funds are available in the account and if a phone line number of the electronic device is active, and not process payment of the purchase cost from the account if the phone line number is inactive. The payment processor may transmit to at least one of the merchant and electronic device an inactive phone message indicating that the phone line number is inactive, and may deny payment of the purchase cost from the account if a phone line number of the electronic device is inactive.

System 1 may be configured such that it is not necessary for customer 14 to sign a credit card receipt or debit card receipt associated with a given purchase/sale. System 1 may also eliminate the need for the merchant to use the Payment Card Industry Data Security Standard (PCIDSS) because the merchant would not accept, transmit or store any cardholder data. Where system 1 requires that the phone line number of ED/phone 4 is active in order for a payment to be processed, one safeguard provided by system 1 relates to when owner 14 loses his or her ED/phone. In particular, to prevent illegal purchases by use of the ED/phone/App 2 (even if a thief could get beyond a bio-ID or other security mechanism, or if the ED/phone had no such security mechanism), the owner may simply contact his or her phone carrier and have them inactivate the phone line number.

System 1 may be configured so that the merchant validation information sent to payment processor program 8 does not include the ED/phone serial number or other ED/phone/phone App identifier inasmuch as the ED/phone serial number or other identifier may not have been communicated from the customer to the merchant/App 6. In this case, the ED/phone serial number or other ED/phone/phone App identifier serves as one piece of customer information which is not communicated from the customer/App 2 to the merchant/App 6 (and which is thus not communicated from the merchant/App 6 to payment processor program 8), but which is communicated from the customer/App 2 to the payment processor program 8. This “missing” piece of customer information may thus preclude the merchant (including the merchant's employees)—as well as anyone accessing customer information which the merchant has procured from the customer—from being able to use the customer's information to illegally make a purchase or steal the missing piece of information. In short, system 1 and the corresponding methods may thus provide for financial transactions with substantially reduced potential of related fraud.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration is an example and not limited to the exact details shown or described.

1. A method comprising the steps of:
receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser;
receiving at the payment processor from an electronic device of the potential purchaser a consumer settlement authorization indicating authorization by the potential purchaser to pay the purchase cost; and
if there is a match between the retailer settlement request and the consumer settlement authorization, the payment processor processing payment of the purchase cost from an account represented by the card number if sufficient funds are available in the account.

2. The method of claim 1 wherein the consumer settlement authorization includes a piece of information which is not included in the retailer settlement request and which necessary for the payment processor to process the payment of the purchase cost from the account.

3. The method of claim 1 wherein the consumer settlement authorization does not include the card number.

4. The method of claim 3 wherein the consumer settlement authorization includes an alias for the credit card or debit card; and further comprising the step of the payment processor extracting the card number from a payment processing database based on the alias.

5. The method of claim 3 further comprising, before the steps of receiving the retailer settlement request and consumer settlement authorization, the steps of
receiving at the payment processor from the electronic device registration information which includes the card number and an alias which is not the card number and which serves as a card identifier of the credit card or debit card; and
storing the card number and alias in a payment processing database which is accessible to the payment processor.

6. The method of claim 1 wherein the consumer settlement authorization comprises merchant sale information which the electronic device received from the merchant.

7. The method of claim 6 wherein the merchant sale information which the electronic device received from the merchant comprises at least one of:
a merchant identification number of the merchant;
a register transaction number which is obtained from a merchant cash register and linked to a potential sale associated with payment of the purchase cost;
a register time which is obtained from a merchant cash register and linked to a potential sale associated with payment of the purchase cost;
a register date which comprises month, day and year and which is obtained from a merchant cash register and linked to a potential sale associated with payment of the purchase cost; and
the purchase cost.

8. The method of claim 1 wherein the retailer settlement request comprises electronic device transaction information which the merchant received from the electronic device.

9. The method of claim 1 further comprising the step of the payment processor extracting the card number from a payment processing database.

10. The method of claim 9 wherein the card number is stored in the payment processing database before the steps of receiving the retailer settlement request and consumer settlement authorization.

11. The method of claim 1 wherein the payment processor does not communicate the card number to the merchant.

12. The method of claim 1 further comprising the step of sending from the payment processor to a phone number validation site an inquiry as to whether a phone line number of the electronic device is active.

13. The method of claim 12 wherein the step of the payment processor processing payment of the cost occurs only if the phone line number is active.

14. The method of claim 12 further comprising the step of transmitting from the payment processor to at least one of the merchant and electronic device an inactive phone message indicating that the phone line number is inactive.

15. The method of claim 1 further comprising the step of the payment processor denying payment of the purchase cost from the account if a phone line number of the electronic device is inactive.

16. The method of claim 1 further comprising the step of transmitting from the payment processor to the electronic device an approval message indicating that payment of the purchase cost from the account has been approved or a denial message indicating that payment of the purchase cost from the account has been denied.

17. The method of claim 1 wherein the retailer settlement request comprises merchant sale information including at least one of:
a merchant identification number of the merchant;
a register transaction number which is obtained from a merchant cash register and linked to a potential sale associated with payment of the purchase cost;
a register time which is obtained from a merchant cash register and linked to a potential sale associated with payment of the purchase cost;
a register date which comprises month, day and year and which is obtained from a merchant cash register and linked to a potential sale associated with payment of the purchase cost; and
the purchase cost.

18. The method of claim 1 wherein the consumer settlement authorization comprises customer transaction information including at least one of:
an electronic device transaction number which is obtained from the electronic device and linked to a potential sale associated with payment of the purchase cost;
an electronic device time which is obtained from the electronic device and linked to a potential sale associated with payment of the purchase cost;
an electronic device date which comprises month, day and year and which is obtained from the electronic device and linked to a potential sale associated with payment of the purchase cost;
a phone line number of the electronic device;
an identifier of the electronic device; and
the purchase cost.

19. A method comprising the steps of:
receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser;
receiving at the payment processor from an electronic device of the potential purchaser a consumer settlement authorization indicating authorization by the potential purchaser to pay the purchase cost; and
transmitting from the payment processor to at least one of the merchant and electronic device (a) an approval message indicating approval of payment of the purchase cost if there is a match between the retailer settlement request and the consumer settlement authorization, or (b) a denial message indicating denial of payment of the purchase cost if there is not a match between the retailer settlement request and the consumer settlement authorization.

20. A method comprising the steps of:
receiving at a payment processor from a merchant a retailer settlement request including a purchase cost of a good or service that a potential purchaser is seeking to purchase from the merchant, wherein the payment processor does not receive from the merchant a card number of a credit card or debit card of the potential purchaser;
receiving at the payment processor from an electronic device of the potential purchaser a consumer settlement authorization indicating authorization by the potential purchaser to pay the purchase cost; and
the payment processor processing payment of the purchase cost from an account represented by the card number if sufficient funds are available in the account and if a phone line number of the electronic device is active, and not processing payment of the purchase cost from the account if the phone line number is inactive.
